(19) United States
(12) Patent Application Publication
(10) Pub. No.: US 2002/0110625 A1
(43) Pub. Date: Aug. 15, 2002

(54) Continuous packaging in enclosed conduits

(75) Inventor: Anthony J.M. Garwood, Mercer Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Case Ready Solutions, LLC.

(21) Appl. No.: 10/037,440

(22) Filed: Jan. 2, 2002

Related U.S. Application Data
(63) Continuation-in-part of application No. PCT/US01/45146, filed on Nov. 28, 2001.
(63) Continuation of application No. 09/724,287, filed on Nov. 28, 2000.
Application No. 09/724,287 is a continuation-in-part of application No. PCT/US00/29038, filed on Oct. 19, 2000.
Application No. PCT/US00/29038 is a continuation of application No. 09/550,399, filed on Apr. 14, 2000, now abandoned.
Application No. PCT/US00/29038 is a continuation of application No. 09/392,074, filed on Sep. 8, 1999, now abandoned.
Application No. 09/392,074 is a continuation of application No. 09/039,150, filed on Mar. 13, 1998, now abandoned.
(60) Provisional application No. 60/255,684, filed on Dec. 13, 2000.
(60) Provisional application No. 60/286,688, filed on Apr. 26, 2001.
(60) Provisional application No. 60/291,872, filed on May 17, 2001.
(60) Provisional application No. 60/299,240, filed on Jun. 18, 2001.
(60) Provisional application No. 60/312,176, filed on Aug. 13, 2001.
(60) Provisional application No. 60/314,109, filed on Aug. 21, 2001.
(60) Provisional application No. 60/323,629, filed on Sep. 19, 2001.
(60) Provisional application No. 60/335,760, filed on Oct. 19, 2001.
(60) Provisional application No. 60/129,595, filed on Apr. 15, 1999.
(60) Provisional application No. 60/141,569, filed on Jun. 29, 1999.
(60) Provisional application No. 60/144,400, filed on Jul. 16, 1999.
(60) Provisional application No. 60/148,227, filed on Jul. 27, 1999.
(60) Provisional application No. 60/149,938, filed on Aug. 19, 1999.
(60) Provisional application No. 60/152,677, filed on Sep. 7, 1999.
(60) Provisional application No. 60/154,068, filed on Sep. 14, 1999.
(60) Provisional application No. 60/160,445, filed on Oct. 19, 1999.
(60) Provisional application No. 60/175,372, filed on Jan. 10, 2000.
(60) Provisional application No. 60/040,556, filed on Mar. 13, 1997.

(51) Int. Cl. C12C 3/04

(52) U.S. Cl. 426/392

(57) ABSTRACT

The invention relates to a package having a first web defining a cavity and a second web bonded to the first web, wherein the second web includes microperforations at a location that is specific to minimize the escape of liquids from the cavity to the exterior of the package. In one particular embodiment, the first web defines a four sided cavity with walls and corresponding flaps attached to the walls that can be folded and bonded to the cavity walls. The second web is an overwrapping lidding web, wherein microperforations are provided on the web material so that the microperforations are aligned with a flap recess, which in turn is in communication with the interior of the tray cavity. In this manner, suitable gas exchange can occur with minimal to no escape of liquids from the tray cavity.

### CROSS-REFERENCES TO RELATED APPLICATIONS

This application is a continuation-in-part of pending application Ser. No. PCT/US01/______ , entitled CONTINUOUS PRODUCTION AND PACKAGING OF PERISHABLE GOODS IN LOW OXYGEN ENVIRONMENTS, filed Nov. 28, 2001, attorney docket number CRSL-1-18064, designating the United States, which in turn is a continuation in part of pending application Ser. No. 09/724,287, filed Nov. 28, 2000, which in turn is a continuation-in-part of pending application Ser. No. PCT/US00/29038, filed Oct. 19, 2000, designating the United States, which in turn is a continuation of U.S. application Ser. No. 09/550,399, filed Apr. 14, 2000, now abandoned, which in turn is a continuation in part of U.S. application Ser. No. 09/392,074, filed Sep. 8, 1999, now abandoned, which in turn is a continuation of U.S. application Ser. No. 09/039,150, filed Mar. 13, 1998, now abandoned, which in turn claims the benefit of U.S. Provisional Application No. 60/040,556, filed Mar. 13, 1997, and claims the benefit of U.S. Provisional Application Nos. 60/129,595, filed Apr. 15, 1999; 60/141,569, filed Jun. 29, 1999; 60/144,400, filed Jul. 16, 1999; 60/148,227, filed Jul. 27, 1999; 60/149,938, filed Aug. 19, 1999; 60/152,677, filed Sep. 7, 1999; 60/154,068, filed Sep. 14, 1999; 60/160,445, filed Oct. 19, 1999; 60/175,372, filed Jan. 10, 2000; 60/255,684, filed Dec. 13, 2000; 60/286,688, filed Apr. 26, 2001; 60/291,872, filed May 17, 2001; 60/299,240, filed Jun. 18, 2001; 60/312,176, filed Aug. 13, 2001; 60/314,109, filed Aug. 21, 2001; 60/323,629, filed Sep. 19, 2001; and 60/335,760, filed Oct. 19, 2001. All the above applications are herein expressly incorporated by reference.

### FIELD OF THE INVENTION

The present invention relates to the continuous packaging of perishable goods in selected gas and most particularly in low oxygen environments, and more specifically, to improvements in plain or printed overwrapping lidding webs for enhanced gas exchange and increased production for controlled atmosphere packaging conduits.

### BACKGROUND OF THE INVENTION

In the previously referenced applications, a method and apparatus is disclosed for the packaging of perishable goods in low oxygen environments within enclosed conduits. The present invention is specifically related to improvements for packaging in enclosed conduits, including, a food item container having gas permeable characteristics that allow atmospheric oxygen gas exchange with the controlled atmosphere within a predetermined time period.

For example, the referenced application PCT/US01/______ , entitled CONTINUOUS PRODUCTION AND PACKAGING OF PERISHABLE GOODS IN LOW OXYGEN ENVIRONMENTS, filed Nov. 28, 2001, attorney docket number CRSL-1-18064, designating the United States, disclosed a method of boning, grinding and subsequent packaging of beef in a substantially oxygen-free environment. In one aspect, these steps occurred in an essentially continuous and enclosed conduit. The method results in a food item, such as beef, having high amounts of deoxymyoglobin. The beef, high in deoxymyoglobin, is then packaged in individual trays and depending on the ultimate destination, may be packaged in master containers. Master containers are used to transport the individual beef packages in a substantially oxygen-free state to the point of sale. In either event, prior to sale, it is desirable that oxygen is exchanged with the controlled atmosphere within the individual packages to allow the beef to produce a bright red color, known as “bloom” (or oxymyoglobin) which is pleasing to consumers. The previous application disclosed trays with means, such as apertures in the tray and in the overwrapping lidding webs at strategic locations to provide for the rapid exchange of the controlled gas within the packaged trays for the oxygen in air outside of the packaged trays with minimal liquid exudate. Other ways of exchanging the controlled atmosphere for air and oxygen included an oxygen permeable package that comprises a polypropylene thermoformed tray with a plasticized polyvinyl chloride web hermetically sealed to the flanges of the tray. In this manner, gas exchange occurs by permeation through the permeable packaging materials.

When a retail package with controlled atmosphere therein, such as the ones just described, is removed form an oxygen-free atmosphere and placed in the normal ambient air atmosphere, the controlled gas in the free spaces on the inside of the package, is displaced by atmospheric gases over time by the normal process of diffusion. It has been observed that a deleterious phenomena can occur to the beef if the oxygen content in the packages is not elevated from 0.05% to at least 3% oxygen within 15 minutes, and sometimes this effect even occurs if the oxygen content of the package is not elevated from 0.05% to at least 10% oxygen within 10 minutes. Within these ranges, it has been observed that the physical and chemical mechanisms taking place on the surface of the beef favor the production of increased amounts of undesirable metmyoglobin relative to the desirable brightly colored red oxymyoglobin. Therefore, it is advantageous to produce methods and materials to surpass these ranges within the allotted time to reduce the production of metmyoglobin and the unsightly appearance caused by it.

Microperforated wrapping materials have been known and used in the food industry; however, one drawback that has been observed is “weeping” of purge or liquids associated with the meat contents through the microperforations, additionally, under other instances, condensation can accumulate on the internal surfaces of the retail package. In this case, water droplets will hinder the diffusion of gases to the extent that the gas exchange can be slowed to several hours. Furthermore, previous attempts to use microperforated materials as an overwrapping web material resulted in direct contact of the microperforated web with the food item of the package. It was later found that “weep”, meaning loss of liquid through the packaging, occurred to such an extent that made it unacceptable to consumers.

Therefore, there is a need to refine the methods and materials useful in the packaging of perishable food items within enclosed conduits, including the use of microperforated lidding webs to provide the desired diffusion rate without allowing the escape of liquids from the package. The present invention fulfills these needs.

### SUMMARY OF THE INVENTION

One aspect of the invention is a package having a first web defining a cavity and a second web bonded to the first web, wherein the second web includes microperforations a location that is specific to minimize the escape of liquids from the cavity to the exterior of the package. In one particular embodiment, the first web defines a four sided cavity with walls, a flange, and corresponding flaps attached to the flange that can be folded and bonded to the cavity walls. The second web is an overwrapping lidding web, wherein microperforations are provided on the lidding web at a predetermined location. For example, the microperforations are aligned with a flap recess, which in turn is in communication with the interior of the tray cavity. In this manner, suitable gas exchange can occur with minimal to no escape of liquids from the tray cavity.

Microperforations of the type that can be produced by lasers can be introduced into the tray or overwrapping lidding web materials to increase the gas exchange to within acceptable limits to, in addition to rapid production of oxymyoglobin (bloom), surpass the zone of rapid metmyoglobin formation.

Another aspect of the invention is a method of exchanging the gas of a controlled atmosphere package with the ambient atmospheric air by including microperforations in a web. In one particular embodiment, a tray web with flaps is overwrapped with a lidding web, wherein the lidding web is provided with the microperforations at a predetermined location, more specifically, adjacent to a flap recess. In this manner the amount of weep is reduced to acceptable quantities or may be eliminated.

Another aspect of the invention is a method of reducing or substantially eliminating the amount of liquid weep from a package by allowing accumulation of the liquid in a recess. In one particular embodiment, a tray web with flaps is overwrapped with a lidding web. The flap includes an enclosed recess that is in communication with the tray cavity. The recess is overwrapped with a lidding web. The lidding web holds the accumulated liquids within the recess of the flap even though the lidding web may be perforated. This is because a nonperforated section of the lidding web, which may be in contact with the liquid, is located adjacent to the recess to hold the accumulated liquids therein.

Another aspect of the invention is a method of bonding a stretched overwrapping lidding web to a tray web with flaps, wherein the lidding web is bonded to the flaps in a substantially horizontal position, and then the flaps are folded and bonded to the tray walls.

Another aspect of the invention is a method of bonding a stretched overwrapping lidding web to a tray web having at least a first and a second flap, wherein the first flap is bonded to the tray wall before the lidding web is bonded to the second flap, wherein the second flap is in a substantially horizontal position. The second flap is then bonded to the tray wall.

Another aspect of the invention is a method of trimming a lidding web from a tray web wherein the tray includes a recess that creates a gap when placed adjacent to a second tray web, and allowing better clearance for a trim device to trim the lidding web from the tray web.

Another aspect of the invention is a tray web forming a cavity with vertical walls, wherein a recessed area is formed on a portion of a flange surrounding the cavity. In this manner, a gap is formed from two or more adjacent trays, such that the trim device can properly cut the lidding web bonded to the trays.

Another aspect of the invention is a method of preventing a contaminant from blocking or otherwise interfering with a bonding surface of a tray web by covering the bonding surface with a guard. Contaminants can include debris, particles, dirt, liquids, bits of food, or any other items. In one particular instance, the guard covers the bonding surfaces of the tray flange and the tray sides, such as flaps, during the loading of food items, which were the food item to contaminate the bonding surfaces, may block or otherwise interfere with the integrity of the hermetic seal between the tray web and an overwrapping lidding web bonded to the sides, such as the flaps. In one instance, the flaps are folded within the guard while loading the food item, and may be bonded to the tray web. However, in other instances, after loading the food item in the tray web cavity, the guard is removed and the flaps are debonded, and moved to a horizontal disposition. Thereafter, an adhesive is applied to the flange and flaps and a lidding web is bonded thereto. The flaps may then be folded and bonded to the tray web again.

In another aspect of the invention, a guard for covering the bonding surface of a tray web includes walls to contain the tray web. The guard also includes a portion to cover the tray flange with a portion that extends into the tray cavity, but the guard includes an opening giving access for loading the tray cavity.

The present invention provides numerous advantages. In one instance, the amount of metmyoglobin formed on the surfaces of beef food items is reduced. Other aspects of the present invention increase the throughput of trays in the packaging conduit. For example, by providing a gap between adjacent tray webs, more trays per unit area of conveyor are allowed in the packaging conduit, because the gap allows for the clearance needed by a trimming device, thus averting the spacing of tray webs farther apart on the conveyor. By folding the leading and trailing flaps of trays before entering the packaging conveyor, more trays per unit area of conveyor are allowed in the packaging conduit. By using an enclosed packaging conduit, the need to use a vacuum chamber to provide a controlled atmosphere, tray by tray, is eliminated. These and other advantages will become apparent from the present disclosure.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a cross section illustration of a packaging conduit according to the present invention;

FIG. 2 shows a top plan illustration of a packaging conduit according to the present invention;

FIG. 3 shows a side illustration of two adjacent tray webs according to the present invention;

FIG. 4 shows a top plan illustration of a packaging conduit according to the present invention;

FIG. 5 shows a perspective illustration of a sealed package according to the present invention;

FIG. 6 shows a top plan illustration of a tray web according to the present invention;

FIG. 7 shows a cross section illustration of tray and lidding webs according to the present invention;

FIG. 8 shows a detail illustration of a communication with serrations between a tray cavity and a flap recess according to the present invention;

FIG. 9 shows a perspective illustration of a flange guard according to the present invention; and

FIG. 10 shows a cross section illustration of a flange guard and tray web according to the present invention.

### DETAILED DESCRIPTION OF THE PREFERRED EMBODIMENT

The aforementioned application PCT/US01/______ , entitled CONTINUOUS PRODUCTION AND PACKAGING OF PERISHABLE GOODS IN LOW OXYGEN ENVIRONMENTS, filed Nov. 28, 2001, attorney docket number CRSL-1-18064, designating the United States, is herein expressly incorporated by reference.

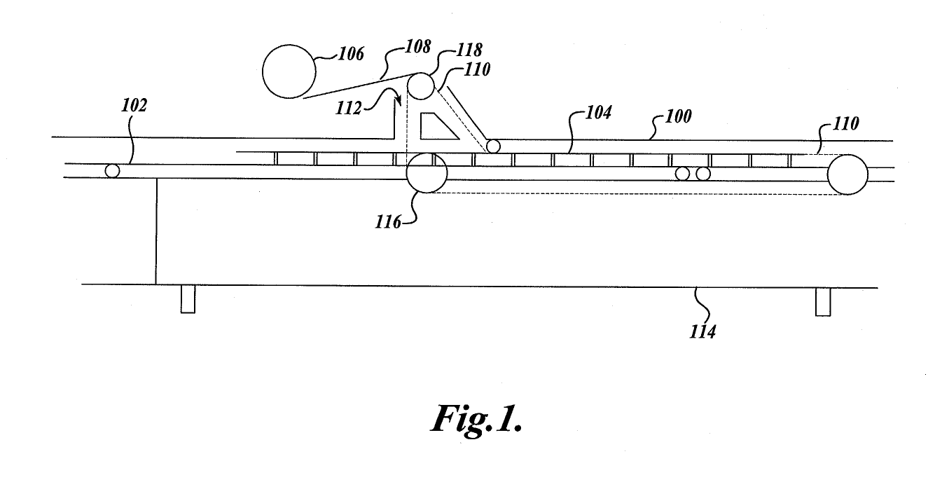

In the aforementioned PCT application, a packaging conduit is disclosed. A schematic of a similar packaging conduit is shown in FIG. 1.

One embodiment of a packaging conduit includes a frame 114 for carrying the conduit 100. Conduit 100 is substantially enclosed to contain any suitable gas or combination of gases, which have been described in the aforementioned PCT application and will not be repeated here. The packaging conduit 100 includes a conveyor 102 for carrying trays 104 containing perishable food items. Conveyor 102 may include a continuous conveyor run running the length of the entire conduit or may be divided into a plurality of more than one conveyor run. The advantage of having more that one conveyor run is to provide different conveyor speeds. This is useful as will become apparent from the disclosure below to “bunch” adjacent trays together at a desirable location, thus increasing the throughput of the packaging conduit and minimizing the amount of lidding web material by eliminating scrap lidding sections that would otherwise occur. Conveyor 102 may include a continuous flat belt on which trays 104 rest, or conveyor 102 may include cleats or brackets to hold trays 104 in position. Flat, smooth belts may allow the sliding of packages in the manner described to bunch trays in close proximity or adjacent to one another.

Packaging conduit 100 includes first and second gripper chains 110 disposed adjacently on either side of conveyor 102, for at least a portion of the conveyor 102. Gripper chains 100 extend along a portion of the conveyor 102 wherein bonding of an overwrapping lidding web takes place. The direction of travel of the gripper chains 110 is adjusted by any number of sprockets 116 to direct motion of gripper chains substantially parallel to conveyor 102 or perpendicular or at any desirable angle. The packaging conduit 100 includes a roll of lidding web material 106. Lidding web roll 106 can be outside of the packaging conduit 100, in which case an opening 112 is provided to allow the passage of lidding web 108 into the packaging conduit 100. Opening 112 can be desirably configured to minimize the escape of any suitable gas within the packaging conduit 100. In one particular instance, gripper chains 110 can take hold of lidding web 108 at either edge thereof at sprocket 118. Gripper chains 110 can apply tension to the lidding web 108 thereto in a transverse direction to the packaging conduit 100. Longitudinal tension may be applied to the lidding web 108 by applying a braking action to the roll of lidding web material 106, while gripper chains 110 pull the lidding web 108 forward. Lidding web 108 is carried into the packaging conduit 100 wherein the lidding web 108 is bonded to surfaces of the tray web 104 including any flange and flaps.

One aspect of the invention is a method of bonding a stretched lidding web 108 to a tray 104 with flaps, wherein the lidding web 108 is bonded to the flaps, while the flaps are in a substantially horizontal position. Once the lidding web 108 is bonded to the flaps, the flaps are next folded and bonded to the tray wall. This operation results in an advantage over methods which sought to first bond the flaps to the tray, and thereafter bond the lidding web to the folded and bonded tray flaps.

Another aspect of the invention is a method of bonding a stretched lidding web 108 to a tray 104 having at least a first and second flap, wherein the first flap is bonded to the tray wall before the lidding web 108 is bonded to the second flap, wherein the second flap is in a substantially horizontal position to the tray. In this instance, bonding the lidding web to the first tray flap is optional, since the bond of the lidding web to a tray flange is adequate to provide for hermetic sealing of the package.

Another aspect of the invention is a method of trimming a lidding web 108 from a tray 104, wherein the tray includes a recessed region around the outer periphery of the tray flange. Thus, when two or more trays are in adjacent disposition, a gap is formed allowing the proper clearance access to a lidding web trimming device between the adjacent trays. This results in numerous advantages. For example, trays can be spaced closer to one another on the packaging conduit conveyor so long as there is sufficient clearance for a trimming device to transversely and longitudinally cut the lidding web 108. In one particular instance, the adjacent trays 104 can be positioned so as to be touching or nearly touching any adjacent trays. In this instance, suitable clearance is provided by the gap between trays to allow the trimming device access to trim the lidding web 108 between adjacent trays 104.

A further aspect of the invention is a package assembled from a tray web with flaps with a cavity wherein the lidding web is bonded to the tray and the lidding web includes microperforations at specific locations to minimize the escape of liquids produced by the perishable food item.

A further aspect of the invention is a method of preventing a contaminant from blocking or otherwise interfering with a bonding surface of a tray web by covering the bonding surface with a guard. Contaminants can include debris, particles, dirt, liquids, bits of food, or any other items common to or used in a packaging operation. In one particular instance, the guard covers the tray flange of a tray web during loading of food items, which were the food item to contaminate the bonding surfaces of the flange, may block or otherwise interfere with the integrity of the hermetic seal between the tray flange and an overwrapping lidding web bonded to the flange. In another embodiment, the guard covers the tray sides, such as flaps, of a tray web during loading of food items, which were the food item to contaminate the bonding surfaces of the flaps, may block or otherwise interfere with the integrity of the hermetic seal between the tray sides, such as flaps, and an overwrapping lidding web bonded to the sides, such as the flaps. In one instance, the flaps are folded within the guard while loading the food item, and may be bonded to the tray web. However, in other instances, after loading the food item in the tray web cavity, the guard is removed and the flaps are debonded, and moved to a horizontal disposition. Thereafter, an adhesive is applied to the flange and flaps and a lidding web is bonded thereto. The flaps may then be folded and bonded to the tray web again.

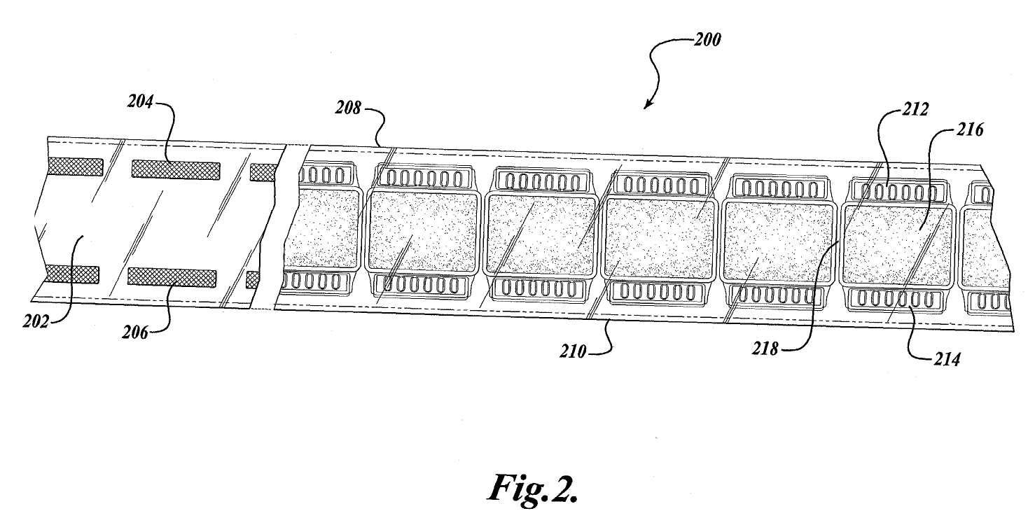

Referring now to FIG. 2, one suitable embodiment of a lidding web 202 and a top side view of a packaging conduit 200 is illustrated. It is to be appreciated that while one row of trays for a packaging conduit is illustrated, any number of tray rows can be provided in a packaging conduit, the single tray row being merely one example. In one embodiment, lidding web 202 can include two areas 204 and 206, respectively, placed at opposite edges of the lidding web 202. Areas 204 and 206 can be areas containing microperforations or alternatively and/or additionally can include printed material. However, it is to be readily appreciated that areas 204 and 206 as shown is merely one example where microperforations can be placed on the lidding web based on one configuration of a tray with flaps herein described. It is to be readily appreciated that other areas not shown in the figure can also include microperforations, the areas 204 and 206 being an example of one embodiment.

Referring now to the top side view of the packaging conduit 200, a section of the apparatus wherein the two horizontally disposed gripper chains 208 and 210 carry a firmly stretched lidding web therebetween, such as lidding web 202, is illustrated.

Lidding web 202 is carried substantially horizontally and directly above a conveyor carrying trays 216 containing food items. In one instance, each tray 216 can have four flaps; however as shown, the flaps disposed on the leading and trailing ends of the trays 216 have been bonded to the tray cavity walls and thus, they are not shown. Alternatively, the trays 216 can eliminate the leading and trailing flaps and provide for the two opposite side flaps 212 and 214. In this instance, a tray flange 218 disposed around the perimeter of the tray cavity will provide sufficient surface area to adequately bond to the lidding web material 202, thus providing a hermetic seal. In either event, flaps 212 and 214 are positioned in a substantially horizontal disposition, which is substantially aligned with the tray flange. Thus, flaps 212 and 214 are not shown bonded to the tray walls. Adhesive is applied to the tray flange and flap areas by any suitable application device. Lidding web 202 is then bonded thereto. Following bonding of the lidding web 202 to the tray flange 218 and flaps 212 and 214, adhesive is applied to the underside of flaps 212 and 214, which are then folded and bonded to the vertically disposed side walls of the tray cavity 216. Lidding web 202 can be perforated and/or printed at sections 204 and 206 as required, either before bonding to the tray or in some instances can be perforated or printed after bonding to the tray thereto. Trimming devices will suitably cut the web both longitudinally and transversely. Any remaining scrap lidding web 208 can be discarded or recycled and reused as desired. One particular benefit of bonding the two leading and trailing flaps that come before and after adjacent trays or alternatively eliminating them is that trays may be stacked closer to one another. In this manner, the throughput of trays through the packaging conduit 200 is increased. Another benefit is that the amount of lidding web 202 used per package is reduced because the amount of spacing between trays is also reduced, leading to fewer quantities of scrap lidding web. However, in other alternates of the present invention, the leading and trailing flaps of the trays may be bonded to a lidding web. Suitable materials for tray webs and lidding webs and methods for making have been described in the aforementioned PCT application and will not be repeated here.

It should be appreciated that once the lidding web is applied to any suitable package, the assembled package can further be packaged within a master container which may contain a plurality of like packages. The master container keeps the individual packages in a substantially oxygen deficient environment until the individual packages are ready to be shelved for display to consumers. While the individual packages remain in the master container there may be exchange of gases from within the individual packages with the interior of the master container. When the individual packages are removed from the master container to the normal ambiert atmosphere containing higher quantities of oxygen, the controlled atmosphere within the packages is displaced by air including oxygen. Under some circumstances, the individual packages may not be stored in a master container, in which case, a form of peelable tab can be applied to the area of microperforations to prevent the premature displacement of controlled atmosphere gas. In this case, the tab may be hermetically sealed to the lidding web by suitable adhesives. The tab is pulled just prior to the packages being shelved for consumer display, exposing the microperforations, and initiating the exchange of gas therethrough.

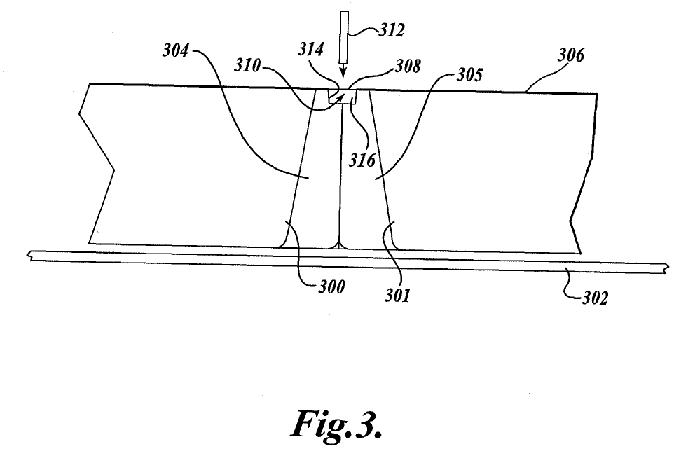

Referring now to FIG. 3, one particular aspect to increase the capacity of a packaging conduit according to the invention is shown. Tray webs 300 and 301 with flaps 304 and 305 are shown in nearly touching or actual touching disposition, wherein flaps 304 and 305 are folded and bonded to trays 300 and 301 on a wall thereof. Trays 300 and 301 are travelling on the conveyor 302 and can be bunched by providing conveyor runs at varying speeds. Flaps 304 and 305 are shown creating a gap clearance 310 by recessing a portion of the outer periphery edge of the tray web at locations 314 and 316, respectively, in flaps 304 and 305. Recesses 314 and 316 may be any suitable shape which when abutted against one another will create the gap 310. Recesses 314 and 316 may be any suitable dimension to allow a desired trimming device, such as slitter device 312, access to cut the lidding web 308. Gap clearance 310 can be provided at any location where two adjacent trays are in close or touching proximity to one another. In this instance, trays 300 and 301 can be spaced in relatively close proximity to one another while allowing the trimming device 312 ample clearance to operate properly. A benefit provided by the present invention is that trays may be closely spaced to each other on the conveyor 302, thus increasing the throughput of packages through the packaging conduit.

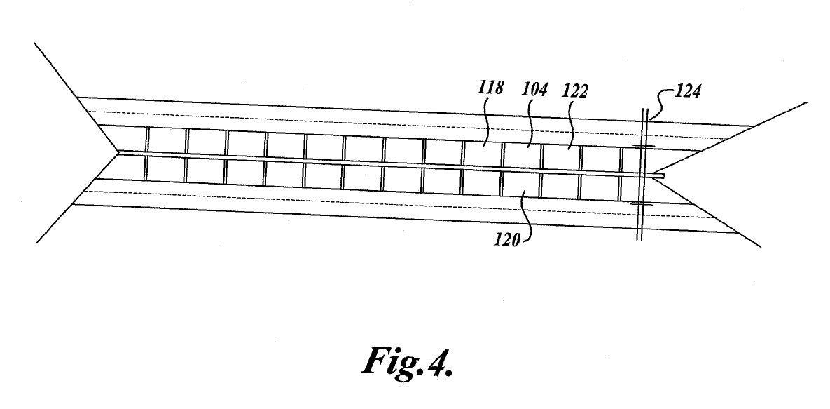

One suitable method for creating the recesses 314 and 316 is known as thermoforming. In thermoforming, suitable molds can be provided which can be arranged as the negative of the eventual tray web. In one instance, raised projections can be provided at a location adjacent to or in close proximity to what will become the outer edge periphery of the tray web or at a portion connecting the tray flange with the respective flaps, such as a hinge. Thus, when ejected from the mold, the projections show up as recesses in the tray web, wherein the recesses appear on what will become the outer edge periphery of the assembled package. In one particular instance, flaps 304 and 305 have been molded to include a recess running lengthwise and front and back of the trays 300 and 301, such that the recesses 314 and 316 are transversely positioned when the tray is arranged in the packaging conduit 100. However, recesses 314 and 316 can be provided around the entire periphery or on three sides for other packaging conduit configurations. For example, in the illustration provided in FIG. 4, two lanes of trays are provided. Therefore, any tray is adjacent to three other trays, and thus, in this instance, a suitable tray, such as tray 104 surrounded by trays 118, 120 and 122 can have three or more sides having recesses to allow gap clearances for suitable lidding web cutting devices. In this instance, tray 104 can have a gap clearance along the longitudinal direction as well as gaps provided in the transverse direction. In this manner, trays can be provided closely spaced to each other on the conveyor in two or more lanes while providing ample clearance for cutting device 124 to operate properly. Cutting device 124 can have a plurality of longitudinally oriented blades to cut the lidding web in the longitudinal direction on either side of trays, as well as have a transverse blade to cut the lidding web in a transverse direction before and after adjacent trays.

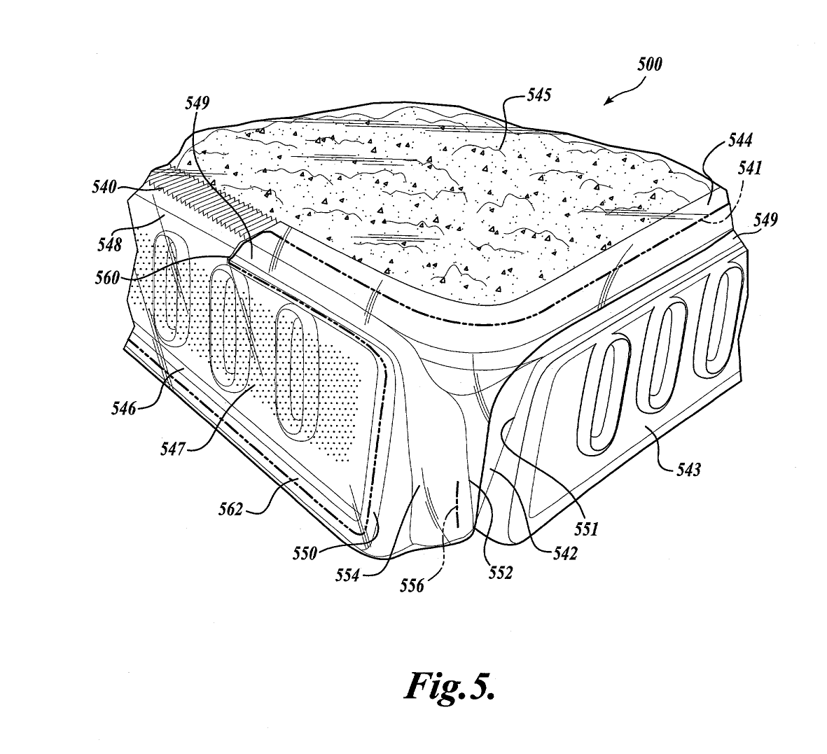

It is to be appreciated that a twin lane stretch sealing machine as depicted is merely one example of the present invention. It is to be appreciated that one, two or more lanes of trays can be provided on the conveyor, the specific configuration shown in the figures being merely one example of the present invention. Referring now to FIG. 5, a three-dimensional view of a comer of a tray with flaps constructed according to the present invention is shown. The tray web 500 has been assembled as a completed package with ground meat 545 placed therein. The tray 500 includes a tray cavity which contains the food item 545. The tray 500 includes a flange 544 constructed around the periphery of the tray cavity. The tray 500 includes a first flap 543 and a second flap 546, bonded to the tray flange 544 at a tray hinge 549. While only a first and second adjacent flaps are shown, it is to be appreciated that oppositely placed flaps to flaps 543 and 546 can be similarly configured. The tray 500 includes a communication which allows the exchange of gases from the tray cavity to a recessed portion of the outward facing side of the flap 546. The flap recess is bordered by a raised surface at location 550, which borders the recess 547, but for the area of the communication 548 to allow for free gas passage therethrough. In this instance, the communication 540 includes serrations 540 formed on the tray flange 544 which may extend downward and include the tray hinge 549. While the particular communication between the cavity and recessed flap area has been shown to include serrations, it is to be appreciated that other methods of establishing communication between the cavity and the flap may be used in the practice of the present invention, serrations being one example. It is also to be appreciated that other methods may include apertures from the tray cavity to the flap. Some examples of which are provided in the aforementioned PCT application.

A lidding web is bonded to the tray 500 in the following manner. To provide a continuous seal of cavity and recess flap portion to a lidding web, a bead of adhesive is provided to unite the cavity and the flap recess as a continuous space with the lidding web. A bead of adhesive 541 is provided at the tray flange 544, such that the adhesive is applied to the upper surfaces of the flange 544. The bead of adhesive continues downward at the communication 560. The bead of adhesive is located about the edges of the flap surfaces that border the flap recess 550 at locations 562. While only a portion of the tray with flaps is shown, it is to be appreciated that an adhesive bead is provided in a similar manner on the opposite side of the flap 546 so that when the lidding web is bonded thereto, the tray cavity forms a continuous united space with the outward facing recess on at least one of the tray flaps.

A lidding web 544 is stretched and applied to the adhesive to form a seal between the tray web and the lidding web and the flap and the lidding web. In this manner, a continuous space is created from the tray cavity and the flap recess that is connected via the communication 540. The lidding web is microperforated at the area 547 that is placed adjacent to the flap recess. In this manner, gas exchange can take place at the location of 547. Gas exchange is further enabled by the serrations 540 which provide for passages from the tray cavity and the flap recess. Thus, enabling gas exchange of the tray cavity with the exterior atmosphere, such as is desired before placing the package for retail sale. The area of microperforations 547 may be smaller than the area of the flap recess. Microperforations can begin at a distance above the lowermost edge of the recess; thus, leaving a portion of nonperforated lidding web between the lowermost recess edge and the area of microperforations 547. In this manner, any liquids that pass from the tray cavity into the flap recess via the communication accumulates at the bottom of the flap recess and kept out of contact from the microperforations and therefore the liquid does not weep from the microperforations. The lidding web is bonded to the tray comer with a bead of adhesive 556 provided to bond the edges 551 and 554 of lidding web to the tray comers.

Referring now to FIG. 6, a top plan view of a section of a tray with flaps is shown. While only two flaps are shown, one end flap 601 and one side flap 605, it should be readily appreciated that oppositely arranged flaps are to be of substantially similar configuration to the flaps shown. A centrally located cavity 603 is enclosed by the four vertically disposed walls of the tray web. The cavity is bordered by a flange 607, substantially continuous and flat at all upper surfaces but for the communication 604. In the area of the communication 604, the flange is provided with serrations 604 which readily allow gases to pass therethrough and into a flap recess 606 via an opening passage 609. The flange 607 which extends around the periphery of the cavity 603 is formed from the tray web. Each tray flap is attached to the flange 607 at a respective hinge 608 which allows the flap to be folded in a downward arcing motion in preparation for bonding to the tray walls. Flaps 601 and 605 are shown to be substantially horizontally disposed in relation to the tray and tray flange 607. Flaps 601 and 605 include a centrally disposed recess portion 606 bordered by raised areas. The outermost reach of the recess is shown by the line with the reference numeral 622. The raised border areas are then bounded by line 622 and the line with reference numeral 624, thus line 622 also marks the boundary of the recess area 606. The border area is open at location 609, thus allowing recess 606 to communicate with the tray cavity 603 therethrough. The raised border area is substantially horizontal with the flange upper surface, while the flap 605 is positioned as shown, and thus, the flange 607 and the border areas can be provided with any suitable adhesive. A continuous bead of adhesive 602 is applied along a path including the flange 607 and the flap 605. The adhesive bead 602 is applied in a manner to unite the cavity 603 and the flap recess 606 into a substantially single space enclosed by the tray and lidding webs. The spaces created by the cavity 603 and the flap recess 606 are joined by communication 609 and 604. To this end, the adhesive bead 602 is applied around the communication 604 and 609 and continues to the raised borders of the flap recess 606. The adhesive bead continuous on an opposite side of the communication 604 on flange 607 so as to form a continuous bead of adhesive enclosing the spaces defined by the cavity 603, the flap recess 606, and the communication 604 and 609 between these two spaces. When a web of overwrapping lidding web is applied on the tray and flaps to the adhesive bead, just described, the tray cavity 603 is joined to the flap recess 606 as a continuous enclosed space joined by the communication 604 and 609 between the two. Location 604 includes serrations formed on the flange 607, which may extend to the hinge 608 and portion of the flap 605. Flaps 601 and 605 may be bonded to the tray with discontinuous adhesive beads 620 applied at flap corner edges. Likewise, lidding web may be bonded to the flap corners with adhesive beads at locations 620 with discontinuous adhesive beads.

The overwrapping lidding web applied to the tray includes an area shown bounded by the dashed line with reference numeral 619. In one instance, the area bounded by 619 is microperforated by suitable laser means such that liquids and any pathogens are restricted from passing therethrough, but gases such as atmospheric oxygen and air can pass directly through the microperforated section through the communication at 609 and 604 and into the tray cavity 603. Likewise, any controlled atmosphere packaging gases contained within the cavity 603 can pass through the communication 604 with serrations and 609 into the flap recess 606 and out through the microperforated area bounded by 619. As can be seen, the area bounded by 619 is smaller than the area bounded by 622, the later marking the boundary of the recess area 606. Thus, it is advantageous to provide an area between the microperforated area 619 and the boundary of the recess 622 that does not include perforations. In this manner, any liquids which pass into the recess 606 will accumulate at the bottom of the cupped recess (i.e., the nonperforated area between lines 622 and 619). While an area of microperforations has been shown to nearly extend to the boundaries of the recess, it is to be appreciated that the eventual area of the microperforations will be determined experimentally for the given circumstances. For instance, the size, number and the spacing of the microperforations may influence the eventual size of the microperforated area. The area shown here being merely one example of a suitable microperforated area. Furthermore, one or more flaps may include areas with microperforations. In addition, tray cavity walls and flaps may alternatively or additionally be microperforated in any location thereof in accordance with the invention to provide gas exchange without release of liquids.

Referring now to FIG. 7, a cross section through a tray web 700 with a lidding web 731 sealed thereto is shown. The tray 700 includes a tray cavity 732 with cavity walls extending upward and substantially vertically or at a small incline from the cavity base 767. It should be readily appreciated that other walls and flaps form the remainder of the tray with flaps, the portion shown in the figure, being merely an example of one suitable flap with recess bonded to a lidding web with microperforations. A flap 733 is bonded to the tray cavity wall by a bead of adhesive applied at location 736.

An outward facing side of the flap 733 defines a recess 738. The recess 738 is bounded by raised borders 739. A lidding web 731 is bonded to the tray flange at the upper surface thereof with an adhesive 735. The lidding web 731 is also bonded to the borders 739 surrounding the recess 738 with adhesives 735. Adhesive is therefore at locations 735 on an upper surface of the tray flange, a vertical surface of the flap adjacent to the flap recess 738 at an upper and lower border 739 thereof. A passage or communication is provided between the tray cavity 732 and the flap recess 738 at the communication 609 and 640 shown in FIG. 6. An area of lidding web 731 denoted by reference numeral 730 includes microperforations. In one instance, the area 730 is spaced a distance from the lower boundary of the flap recess 738 at location 734. In this manner, any liquids that may flow from the tray cavity 738 into the recess are prevented from exiting and accumulate in the flap recess 738. The liquids are retained within the flap recess 738 by the lidding web 731 that is nonperforated and is located between the lower most boundary of the microperforated area 730 and the lower boundary of the flap recess 734. In this manner, liquids are substantially kept away from microperforated areas and prevented from exiting to the exterior of the package. Thus, one advantage of the present invention is the elimination of liquid weep in many instances.

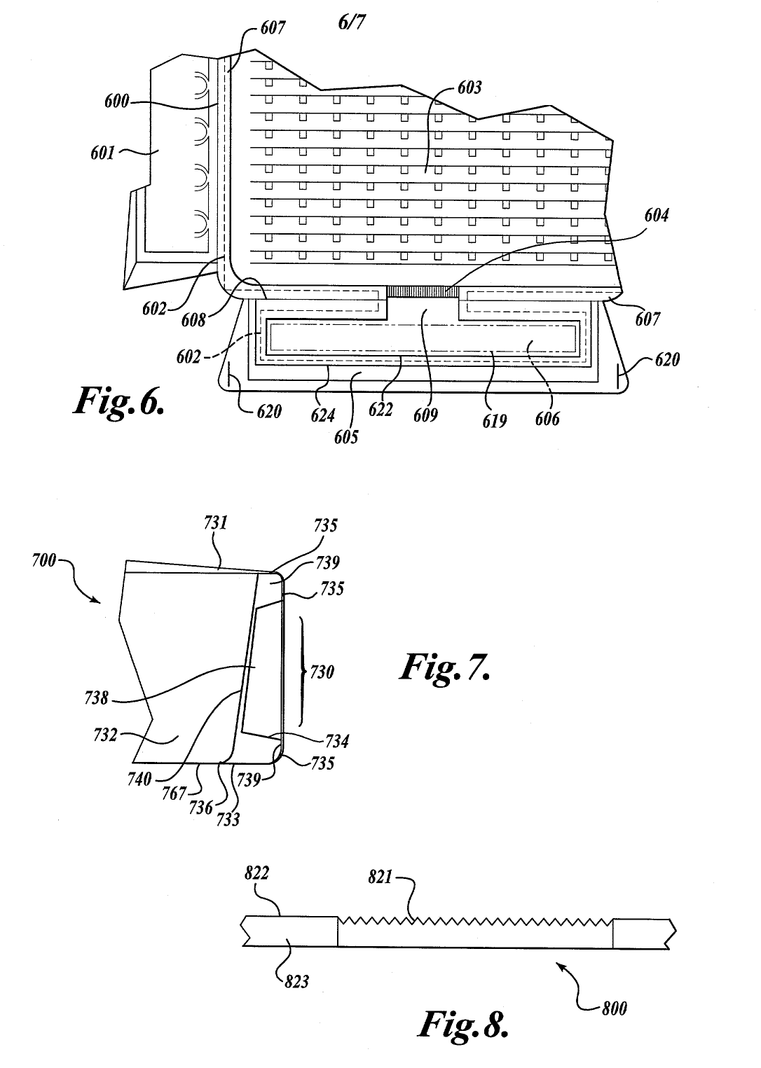

Referring now to FIG. 8, one example of a gas exchange communication between a tray cavity and a flap recess is shown. The communication 800 is formed in a tray flange 823. The tray flange 823 is shown to be recessed, wherein the recessed portion can accommodate serrations 821 therein. The serrations can be the full width of the flange 823 or the serrations can be less than the full width of the flange 823 to leave a flat area. The serrations can be located at either the inner edge or the outer edge of the flange 823. The serrations can also continue downward throughout the thickness of the tray flange 823. The serrations maintain the lidding web 822 from collapse around the communication 800, yet allow the passage of gases therethrough. While one example of gas exchange communication has been shown and described, it is to be appreciated that other communications between tray cavities and flap recesses are within the scope of the present invention. For example, numerous communication passages and apertures and other examples of communicating between a tray cavity and a flap recess are provided in the aforementioned PCT application. It is also to be appreciated that the tray with flaps web is formed from any of the methods and materials also mentioned in the PCT application.

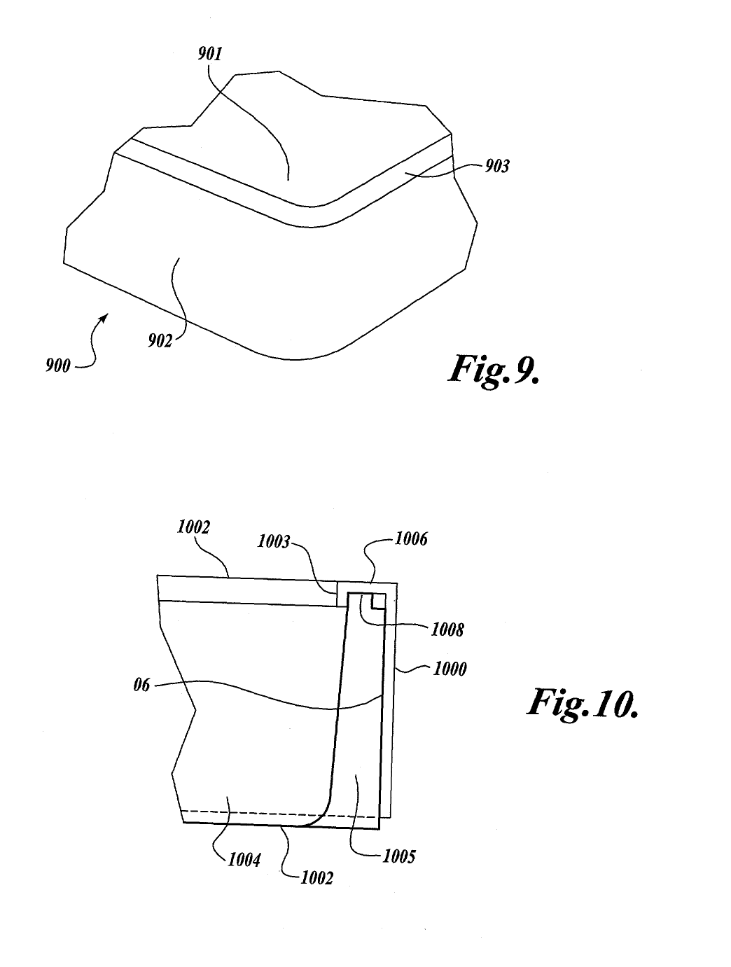

Referring now to FIG. 9, a guard for covering a tray web is illustrated. The guard is used in preventing a contaminant, such as a food item, from blocking or otherwise interfering with a bonding or sealing surface of a tray web by covering the bonding surface during packaging, including during the loading of the food item within the tray cavity. The guard 900 includes walls 902, vertically disposed and connected to adjacent walls at a corner section, thus forming a box like structure having no bottom. While only a first and second wall are shown, it is apparent that the opposite walls are configured similar to the two that are shown. The height and length of guard walls 902 can be adjusted to coincide with any suitable tray web height and length, including a tray web with flaps. It is also appreciated that the guard 900 can be configured and adjusted in any manner to contain the tray web with the flaps in a folded disposition, meaning the flaps of the tray web have been placed adjacent to the tray cavity prior to placing the guard on the tray web. The guard 900 can also be configured to be used while the flaps are in an open disposition, meaning the flaps are not adjacent to the tray web. Upper portions of the walls 902 extend inwardly and horizontally forming a horizontal shelf 903 to coincide with the flange of any suitable tray web. The horizontally extending shelf 903 terminates substantially coextensively with the tray cavity to provide an opening for loading accessibility to the tray cavity. However, the shelf 903 may extend further in toward the tray cavity, and in some instances includes a lip that extends into the tray cavity. It is to be appreciated that some amount of misalignment when placing the guard over a tray web can be tolerated, and thus the walls and shelf need not be exactly dimensioned to the tray web.

Referring now to FIG. 10, a cross section of a guard 1000 and tray web 1002 defining a cavity 1004, flange 1008 and flaps 1005, is illustrated. Tray web flaps 1005 are in close and sometimes firm contact with the internal sides of guard walls 1000. Guard 1000 includes a horizontal shelf 1006 at an upper portion of the guard walls 1000. Shelf 1006 is directed inward from walls and terminates to form an opening 1002 to provide accessibility to the tray cavity 1004 for loading the food item. Wall 1000 covers flap 1005 at an exterior side thereof during packaging, including loading a food item, which were the food item to spill in the area of the flap bonding surface, the spilled food item would block or otherwise interfere with a hermetic seal from being formed thereon. Shelf 1006 covers flange 1008 at an upper surface thereof during packaging, including loading a food item, which were the food item to spill in the area of the flange bonding surface, the spilled food item would potentially block or otherwise interfere with a hermetic seal from being formed thereon. Shelf 1006 includes a lip 1003. Lip 1003 is formed vertically to partly enter the tray cavity 1004. Any amount of protrusion of lip 1003 into the tray cavity is advantageous, as the lip 1003 prevents contaminants from contact with the flange 1008.

The guard can be made using conventional plastic or metal materials. In one instance, the guard can be made utilizing plastic injection molding. However, the guard can also be made by thermoforming. The guard is reusable after each use by sanitizing in an appropriate manner. The guard can be manually placed on the individual tray webs during packaging, and before loading of any food items. However, in other instances, the guard can be automatically placed by machine over the tray webs. The guards can be attached to a continuous conveyor, wherein the trays are located within the guard at a first location on the conveyor and the trays are removed at a second location, where the trays can enter a stretch sealing apparatus, for example. In one instance, if the tray web includes flaps, the flaps may be folded, and additionally or alternatively can be bonded to the tray web, before placement of the tray web within the guard. In another instance, the flaps can be lightly bonded to the tray web with a spot of pressure sensitive adhesive. In this manner, the tray web size is minimized, rendering the tray web easier to handle. Once the food item is loaded, the guard is removed and the flaps can be opened to a substantially horizontal disposition and an adhesive can be applied thereto and to the flange in the manner described above. A stretched lidding web can then be bonded to the adhesive to create a hermetic seal between the tray web and the lidding web. The lidding web can be microperforated and additionally can include printed material on a portion thereof. Following bonding of the lidding web to the tray web, the flaps may be more rigidly bonded to the tray web.

In one instance, microperforation of lidding webs may be performed by lasers. Microperforation of lidding webs can take place before or after bonding to the tray web. Furthermore, printing in the areas of microperforations may also take place with microperforation without hindering the ability of the microperforations to perform as desired. Suitable laser techniques and methods for use in the present invention can be provided by the Rofin Company. Information concerning laser techniques can be located at their Web site http:\\www.rofin-sinar.com\home-e.htm. Microperforations as small as 0.1 mm (0.004 inch) diameter can be provided by these techniques. Other entities capable of performing suitable microperforations by laser include Laser Machining Inc. of Somerset, Wis. Information about Laser Machining Inc. is available at their Web site www.lasermachining.com\company\company.htm. By use of a carbon dioxide laser, microperforations in the range of 40-400 μm and perforation speeds as high as 500,000 holes per second can be achieved. While proportions and methods of providing microperforations have been provided with reference to two makers, it is to be appreciated that other methods of making exist which can be used in the present invention, such methods can include mechanical methods, such as puncturing the lidding web with pins of suitable diameter. Other methods can utilize high voltage corona discharge. The methods of making and proportions herein described being merely examples. Other dimensions of microperforations less than or greater than the dimensions herein described can be used to practice the present invention, the dimensions described herein being examples.

In one instance, suitable adhesives for use in the present invention are known as pressure sensitive adhesives (PSA's). Suitable adhesives are provided by the National Starch and Chemical Company of Bridgewater, N.J. For instance, one example of a suitable adhesive for use in the present invention is known by the trademark DURO-TAK34-449A. DURO-TAK34-449A is a family of hot melt pressure sensitive adhesives designed for direct food contact. Further information can be obtained from the National Starch and Chemical Company. However, it should be readily appreciated that the adhesive disclosed herein is merely one example of a suitable adhesive for use in the present invention. Other suitable adhesives are well known to those in the art. Further examples of suitable adhesives have been provided in the aforementioned PCT application and will not be repeated here.

Some of the advantages of using a pressure sensitive adhesive as opposed to a heat sealable lidding web is the elimination of a heating bank. Pressure sensitive adhesives are thus quicker to apply and do not require a heating or setting time as is required of heat sealable materials. Furthermore, by using a packaging conduit for controlled atmosphere packaging, the use of vacuum chambers for individually evacuating each tray of oxygen and substituting therefor a suitable gas is eliminated. Furthermore, the use of pressure sensitive adhesives eliminate the need to have a heat sealable layer as part of the lidding web composite. This reduces the amount of scrap material and in some instances heat sealable material is not reusable or recyclable, making the use of pressure sensitive adhesives much more economical and advantageous. If desired however, a heat sealable lidding web can be used in the present invention. Heat sealable materials are mentioned in the aforementioned PCT application.

One aspect of the present invention has evolved due to the discovery that bonding a stretched lidding web to the sides of a tray, while not impossible, presents certain difficulties. Therefore, it is one aspect of the present invention to provide a method which can readily bond a lidding web to a tray web having flaps.

In one aspect of the invention, a tray is loaded with a food item. The tray is then carried on a conveyor and the flaps are substantially horizontally disposed so as to extend outwardly from the tray walls. FIG. 6 described above shows one instance of a tray with horizontally disposed flaps before bonding of the flaps to the tray walls. A suitable adhesive, such as a pressure sensitive adhesive, is then applied to the flange and to the flaps at locations where desired bonding of the tray with the lidding web is to take place. Flaps can be supported by supports on the conveyor to substantially stay in a horizontal disposition until desired to be folded and bonded to the tray walls. The stretched lidding web is brought into contact with the pressure sensitive adhesive applied to the flaps and to the tray flange. The lidding web is then severed in a longitudinal and transverse manner, thus allowing the flaps with bonded lidding web thereto to fold in a downward motion. A suitable adhesive is applied, in one instance, on the tray cavity walls and the flaps are folded and bonded thereto. In one particular instance, the lidding web can be perforated at desired locations such as described hereinabove or additionally or alternatively, the lidding web can be provided with printed material on sides of the tray.

In another embodiment of the present invention, two of the four flaps of a tray can be selectively bonded to the tray cavity walls without a lidding web bonded to the flap, while the remaining two flaps can be bonded to the lidding web followed by severing the lidding web and bonding of the flaps with lidding web to the tray cavity walls. The two flaps that are folded in advance of this step may or may not be provided with a lidding web bonded thereto. In any event, when adhesive is provided to the tray flange, adequate hermetic sealing of the lidding web to the tray occurs even though the lidding web may not extend to the folded flaps. In one particular instance, a food tray having four flaps is loaded with a food item. A suitable adhesive, such as a pressure sensitive adhesive can be applied to the tray flange and the two horizontally disposed flaps. A lidding web having microperforations and printing thereon at specific locations can be stretched and bonded to the tray flange and the flaps. Suitable cutting devices can trim the lidding web both longitudinally and across the tray. The two horizontally disposed flaps are folded in a downward motion and are bonded to the vertical cavity walls. In this manner, by bonding leading and trailing flaps (FIG. 2), trays are in close and sometimes touching proximity to one another, thus increasing the capacity of the packaging conduit. In this instance, since two of the four flaps have been provided with a lidding web, it is convenient to have communication between the tray cavity and the flap recess on one or both of these longitudinal sides.

In further aspects of the present invention, in addition to the lidding web being microperforated, the tray can as well be perforated at strategic locations to increase the exchange of controlled atmosphere gas with air including oxygen. For instance, microperforations on the tray can be located on the tray cavity walls and the flap walls to provide some communication between gases from the tray cavity to the flap recess.

Many variables can be experimented with to achieve the desired gas exchange rate. For example, the area, number and size of microperforations can be increased or decreased to meet the desired gas exchange rates, or any combination of these variable. For instance, these variables independently or in combination can be manipulated so that the level of oxygen within the tray cavity can be elevated from less than or about 0.05% (500 ppm) oxygen to greater than or about 10% (100,000 ppm) oxygen within less than or about 10 minutes. However, under other circumstances, the level of oxygen within the tray cavity can be elevated from less than or about 0.05% (500 ppm) oxygen to greater than or about 3% (30,000) oxygen within less than or about 15 minutes. The diffusion and gas exchange rates can vary based on a number of variables. For instance, the diameter of microperforations can be adjusted to an optimum, taking into consideration the desired gas exchange rate and the need to reduce the amount of liquid weep. Other variables that may be considered is the amount of free space volume within the tray cavity, the volume of the communication, and the volume of the flap recess. Greater volumes can add to the time for sufficient gas exchange to take place. Other variables, not mentioned here are also considered to affect the gas exchange rate and can be taken into consideration by varying the area of microperforations, the amount of microperforations, the spacing between perforations and the diameter and location of the microperforations, to name a few examples. These variables can again be determined experimentally to meet the desired application. Other variables which may or may not be under the control of the designer may effect the gas exchange, such as temperature, pressure, humidity, air composition, etc., and can be accomodated in the manner described.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. a package, comprising:
a first web defining a cavity; and
a second web bonded to the first web, wherein the second web includes microperforations at predetermined locations.

2. The package of claim 1, wherein the microperforations are located at a substantially horizontal portion of the second web and adjacent to a first web recess in communication with the cavity.

3. The package of claim 2, wherein the first web includes a flange to connect said recess to the cavity.

4. The package of claim 3, wherein the flange defines a communication from the cavity to the recess.

5. The package of claim 4, wherein the communication defines serrations on the flange.

6. The package of claim 5, including a nonperforated area of the second web adjacent to the recess of the first web.

7. A method of exchanging the gas of a controlled atmosphere package with air by including microperforations in a web.

8. The method of claim 7, wherein the exchange of gas raises the oxygen concentration of the package from less than or about 0.05% to greater than or about 3% within about 15 minutes.

9. The method of claim 7, wherein the exchange of gas raises the oxygen concentration of the package from less than or about 0.05% to greater than or about 10% within about 10 minutes.

10. The method of claim 7, wherein the package is assembled from a tray web having a cavity and flaps, wherein at least one flap includes a recess formed from the outwardly facing side.

11. The method of claim 10, wherein gas exchange occurs through a communication between the cavity and the flap recess, wherein the communication includes serrations.

12. A method of reducing liquid weep from packages using microperforated lidding webs by locating a section of nonperforated lidding web adjacent to a recess.

13. The method of claim 12, wherein the package is formed from a tray web having a cavity and flaps, and wherein at least one flap includes a recess formed from the outwardly facing side.

14. A method of bonding a stretched lidding web to a tray web with flaps, wherein the lidding web is bonded to the flaps in a substantially horizontal position.

15. The method of claim 14, further comprising folding and bonding the flaps to the tray web.

16. A method of bonding a stretched lidding web to a tray web having at least a first and second flap, wherein the first flap is bonded to the tray before the lidding web is bonded to the second flap, and wherein the second flap is in a substantially horizontal position.

17. The method of claim 16, further comprising folding and bonding the second flap to the tray web.

18. A method for trimming lidding web from a tray web, wherein the tray web includes a recess allowing clearance for a trimming device.

19. A tray, comprising:
a web forming a cavity, wherein a recess is formed on a portion of the web to create a gap clearance when a first and second web abuts or is in close proximity to the first web.

20. A method for preventing a contaminant from blocking a bonding surface of a tray web by covering the bonding surface with a guard.

21. The method of claim 20, further comprising covering a top and side portion of the tray web.

22. The method of claim 20, wherein the tray web comprises flaps, wherein the flaps are contained within the guard.

23. The method of claim 22, wherein the flaps are bonded to the tray web.

24. The method of claim 23, wherein the flaps are debonded and substantially horizontal when bonding a lidding web to the tray web.

25. The method of claim 24, further comprising a second bonding of the flaps to the tray web.

26. The method of claim 20, further comprising loading a food item with the guard in place.

27. A guard for covering a tray web defining a flange and cavity, comprising:
a guard body having walls to contain a tray web therein, with a body portion covering the tray flange; and
an opening giving access for loading the tray cavity.

28. The guard of claim 27, further comprising a lip extending partly into the tray cavity.
